(19) United States
(12) Patent Application Publication
(10) Pub. No.: US 2006/0038441 A1
(43) Pub. Date: Feb. 23, 2006

(54) Connecting device

(75) Inventors: Aurelien Justaman, (US); Sylvain Lenczner, Paris (FR); Jean-Michel L'Aot, Stains (FR); Nicolas L'Opez Da Cruz, Aulnay Sous Bois (FR); Olivier Beaures D'Augeres, Paris (FR)

Correspondence Address: LEO H MCCORMICK, 2112 MISHAWAKA AVE, P O BOX 4721, SOUTH BEND, IN, 46634, US

(73) Assignee: Robert Bosch GmbH

(21) Appl. No.: 11/196,860

(22) Filed: Aug. 4, 2005

(30) Foreign Application Priority Data
Aug. 19, 2004 (FR) 04/08970

(51) Int. Cl. F16D 55/00

(52) U.S. Cl. 303/115.1; 188/73.31

(57) ABSTRACT

A connection device for a brake fluid reservoir intended to link an outlet (10) of a brake fluid reservoir (1) to the supply inlet (20) of the primary circuit and to the supply inlet (21) of the secondary circuit of a master brake cylinder (2) or to two supply inlets (40, 41) of a manifold device (4) mounted on the said supply inlets of the master cylinder. A pipe system (3) has a main pipe (30) to which two branch pipes (31, 32) are connected. The main pipe (30) has an inlet end (33) connected to the outlet of the brake fluid reservoir and each branch pipe has a supply end (34, 35) that is connected to a supply inlet (20, 21) of the master cylinder or to an inlet (40, 41) of the manifold device (4).

The invention relates to a connection device for a brake fluid reservoir and particularly a connection device between a brake fluid reservoir and a master cylinder.

### BACKGROUND OF THE INVENTION

In motor vehicles, the brake fluid reservoir is routinely mounted directly on the master cylinder of the vehicle's braking hydraulic circuit. The reservoir must therefore be adapted to suit the master cylinder, in particular the reservoir outlets must have their dimensions and their positions adapted to suit the supply inlet of the master cylinder. In addition, the reservoir and hence the master cylinder associated with it must be situated in accessible locations to allow the brake fluid level to be visually checked and to allow the reservoir to be filled with brake fluid.

To resolve these disadvantages, the reservoir is not mounted directly on the master cylinder. Pipes then connect the outlet or outlets of the reservoir to the brake master cylinder supply inlets. A brake fluid manifold device may, mounted on the master cylinder supply inlets, then be provided to distribute the brake fluid between the primary circuit and the secondary circuit of the master cylinder. The brake fluid reservoir may be linked to the master cylinder or to the manifold device by two separate tubes which results in a longer and bulkier assembly, or by a single tube but in this case, in the event of a leak in one of the vehicle's braking circuits, the possible brake fluid reserve for the other braking circuit simply consists of only the manifold part which supplies this braking circuit.

### SUMMARY OF THE INVENTION

The invention makes it possible to overcome these disadvantages.

The invention therefore relates to a connection device for a brake fluid reservoir intended to link an outlet of a brake fluid reservoir to the supply inlet of the primary circuit and to the supply inlet of the secondary circuit of a master brake cylinder or to two supply inlets of a manifold device mounted on the said supply inlets of the master cylinder. The connection device comprises a pipe system having a main pipe to which two branch pipes are connected. The main pipe has an inlet end intended to be connected to the outlet of the brake fluid reservoir and each branch pipe has a supply end each intended to be connected to a supply inlet of the master cylinder or to an inlet of the manifold device.

Advantageously, the two branch pipes are connected in Y formation to the main pipe.

Equally, it would be advantageous to provide that the separation between the branch pipes comprises a separation membrane which extends inside the main pipe.

The various aspects and features of the invention will appear more clearly in the following description and in the appended figures.

### BRIEF DESCRIPTION OF THE DRAWINGS

FIGS. 1a and 1b, a view in perspective of the device of the invention;

FIGS. 2a and 2b, top views of the device of FIG. 1;

FIGS. 3a and 3b, an exemplary embodiment of the pipe system according to the invention; and

FIGS. 4a and 4b, variant embodiments of the pipe system according to the invention.

### DETAILED DESCRIPTION OF THE INVENTION

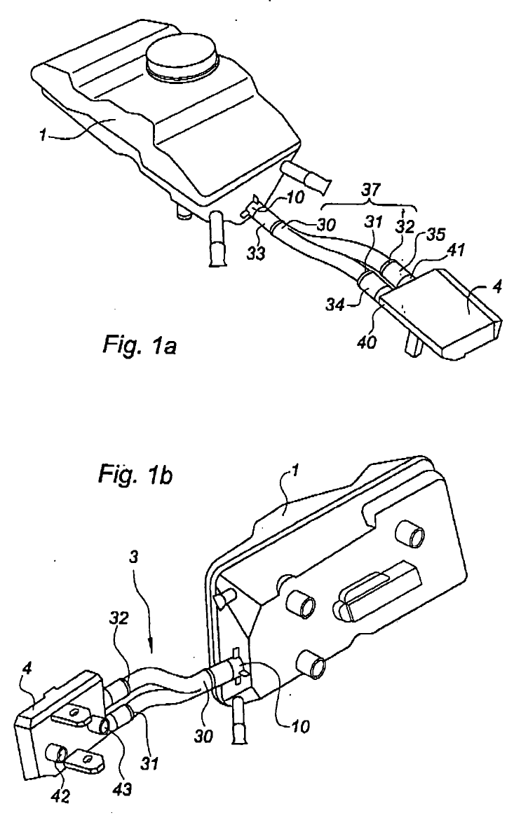

With reference to FIG. 1, a description will first be given of an exemplary embodiment of the device according to the invention.

FIG. 1 represents a brake fluid reservoir 1. A manifold 4 intended to be mounted on the supply inlets of a master brake cylinder is linked via a pipe system 3 to the reservoir 1.

According to the invention, the reservoir has only one supply outlet 10 linked to the manifold which has two supply inlets 40 and 41.

The pipe system 3 has a main pipe 30 which is divided into two branch pipes or branches 31 and 32. The end 33 of the main pipe is connected to the outlet 10 of the reservoir. The ends 34 and 35 of the branch pipes are each connected to a supply inlet 40, 41 of the manifold 4. The two supply inlets 40, 41 are therefore both supplied with brake fluid by the liquid contained in the reservoir 1.

FIG. 1b shows a view in perspective from below of the device of FIG. 1a. This Figure. 1b shows the outlet orifices 42 and 43 of the manifold 4. These orifices are intended to be connected to supply inlets of a master cylinder not shown in the figures.

According to a variant embodiment not shown, the ends 34 and 35 of the branch pipes 31 and 32 could be connected directly to the supply inlets of the primary and secondary circuits of a master cylinder. In this case, each branch pipe 31 and 32 constitutes, for the braking circuit that it supplies, a reserve of brake fluid in the event of one or other braking circuit being faulty and exhibiting a leak.

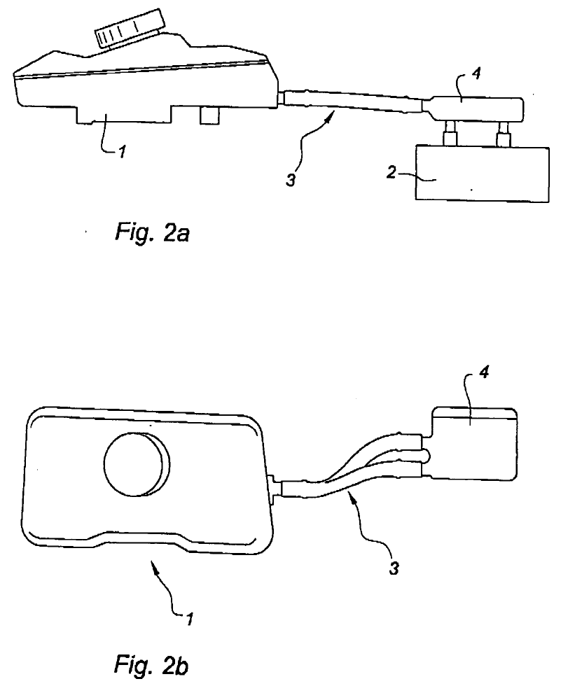

FIGS. 2a and 2b represent respectively a top view and a side view of the device previously described. According to this exemplary embodiment, the pipe system 3 has its axes contained substantially in one plane.

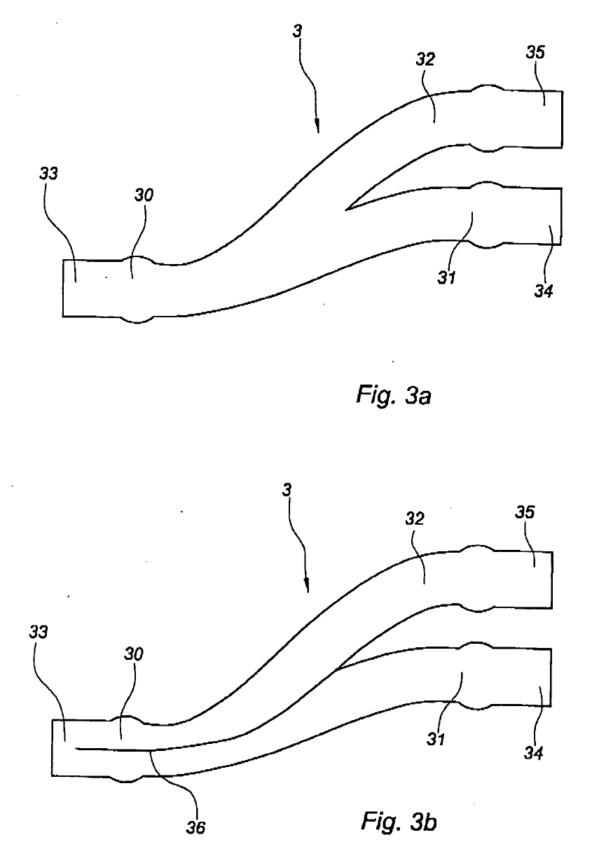

FIG. 3a shows the pipe system 3 in sectional view. The two branch pipes 31 and 32 are therefore both connected to the main pipe 30. The separation between the two branch pipes may comprise a separation membrane 36 which extends toward the main pipe or even inside the main pipe as shown in FIG. 3b.

In the event of a leak in one of the primary or secondary braking circuits, the brake fluid contained in the reservoir risks flowing through the faulty circuit. On the other hand, the branch pipe which feeds brake fluid to the braking circuit that is not faulty will serve as a reserve for this circuit. It may therefore be worthwhile to provide a separation membrane 36 which travels back as far as possible in the main pipe to increase this reserve. Specifically, the brake fluid contained in the branch pipe and situated on the side of this branch pipe relative to the separation membrane 36 cannot flow through the faulty circuit.

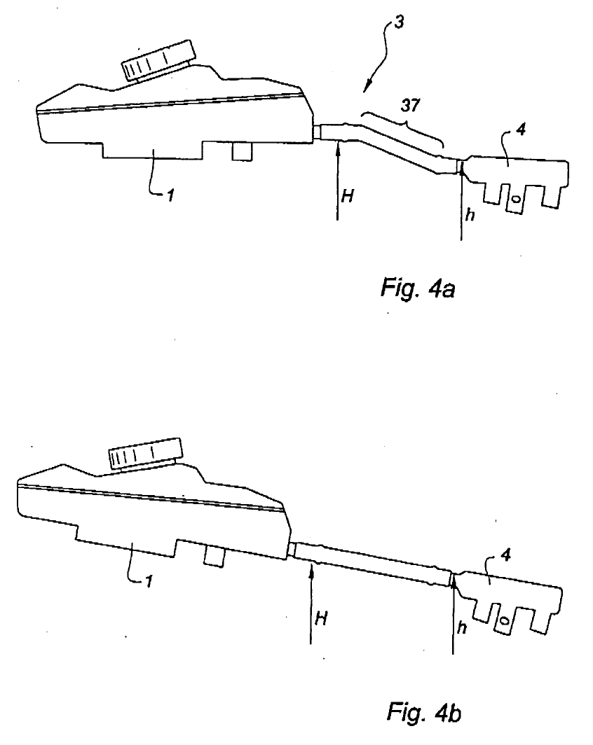

As shown in FIG. 4a, a pipe system 3 having a curve in the zone 37 may also be provided so that the reservoir 1 is at a height H substantially greater than the level h of the supply inlets 40 and 41.

According to a variant, as shown in FIG. 4b, a configuration may also be provided in which the reservoir and the manifold and/or the master cylinder are inclined so that, as above, the bottom part of the reservoir outlet 10 is at a level H greater than the level h of the top part of the manifold inlets 40 and 41 of the master cylinder.

What is claimed is:

1. A connection device for a brake fluid reservoir for linking an outlet (10) of a brake fluid reservoir (1) to a supply inlet (20) of a primary circuit and to an supply inlet (21) of a secondary circuit of a master brake cylinder (2) or to two supply inlets (40, 41) of a manifold device (4) mounted on the said supply inlets of the master cylinder, characterized in that the connection comprises a pipe system (3) having a main pipe (30) to which two branch pipes (31, 32) are connected, the main pipe (30) having an inlet end (33) connected to the outlet (10) of the brake fluid reservoir and each branch pipe having a supply end (34, 35) each connected to a supply inlet (20, 21) of the master cylinder or to an inlet (40, 41) of the manifold device (4).

2. The connection device for a brake fluid reservoir according to claim 1, characterized in that the two branch pipes (31 and 32) are connected in a Y formation to the main pipe (30).

3. The connection device for a brake fluid reservoir according to claim 1, characterized in that the separation between the branch pipes (31, 32) comprises a separation membrane (36) which extends inside the main pipe (30).
